(19) United States
(12) Patent Application Publication
(10) Pub. No.: US 2025/0333664 A1
(43) Pub. Date: Oct. 30, 2025

(54) DETERGENT COMPOSITIONS WITH CARRY-OVER ENHANCERS FOR COLOR PROTECTION

(71) Applicant: Henkel AG & Co. KGaA, Duesseldorf (DE)

(72) Inventors: Yolanda Lunn Li, Stamford, CT (US); Kyle Seamus Joseph O’Connor, Stamford, CT (US); Daniel Thomas Piorkowski, Fairfield, CT (US)

(21) Appl. No.: 19/189,355

(22) Filed: Apr. 25, 2025

Related U.S. Application Data
(60) Provisional application No. 63/639,296, filed on Apr. 26, 2024.

(51) Int. Cl. C11D 3/30; C11D 3/00; C11D 3/37

(52) U.S. Cl. CPC C11D 3/30; C11D 3/0036; C11D 3/3715; C11D 3/3765; C11D 2111/12

(57) ABSTRACT

Detergent compositions comprising a chlorine scavenger agent and a carry-over enhancer agent provide chlorine scavenging in both the wash and rinse cycles.

### CROSS-REFERENCE TO RELATED APPLICATION

This application claims priority to and the benefit of U.S. Provisional Patent Application No. 63/639,296, filed on Apr. 26, 2024. The related application is incorporated herein by reference in its entirety.

### BACKGROUND

In the U.S., municipal water is chlorinated as part of the disinfection process. While this has brought many benefits, it is also a major cause of textile color fading during the laundry process. M any dyes react with hypochlorite in the water which results in a bleaching/fading effect as early as the first wash. This exposure to chlorinated water occurs during both the wash and rinse step of the laundry process. Although technologies exist to scavenge chlorine in the wash cycle, carry over into the rinse cycle has not been identified.

There remains a need in the art for compositions that can scavenge chlorine in both the wash and rinse cycles of a laundering process.

### SUMMARY

Disclosed, in various embodiments, are detergent compositions comprising a chlorine scavenger agent and a carry-over enhancer agent that synergistically work to scavenge chlorine in both the wash and rinse.

In an embodiment, a detergent composition comprises 5.0 to about 30 weight percent (wt %) of an anionic surfactant; about 0.5% to about 10 wt % of a chlorine scavenger agent; about 0.1 to about 2 wt % of a carry-over enhancer agent, wherein the carry-over enhancer agent is a soil-release polymer, an anti-redeposition polymer, a cationic surfactant, a cationic polymer, a silicone-based polymer, or a combination thereof; and at least 30 wt % water; all weights are based on the total weight of the detergent composition; and wherein the detergent composition is free of a dye transfer inhibitor agent.

In another embodiment, a detergent composition comprises 5.0 to about 30 wt % of an anionic surfactant comprising a sodium laureth sulfate and a linear alkylbenzene sulfonic acid; about 0.5% to about 10 wt % of monoethanolamine; about 0.1 to about 2 wt % of a carry-over enhancer agent, wherein the carry-over enhancer agent is a soil-release polymer, an anti-redeposition polymer, a cationic surfactant, a cationic polymer, a silicone-based polymer, or a combination thereof; an alkoxylated fatty alcohol; and at least 30 wt % water; all weights are based on the total weight of the detergent composition; and wherein the detergent composition is free of a dye transfer inhibitor agent.

In another embodiment, a method of enhancing the chlorine scavenging ability of a detergent composition in a laundry rinse cycle comprises administering a detergent composition comprising a chlorine scavenger agent and a carry-over enhancer agent as described herein in a wash cycle of a laundry washing process comprising a wash cycle followed by a rinse cycle.

### DETAILED DESCRIPTION

Disclosed herein are laundry detergent compositions containing a chlorine scavenger and a carry-over enhancer agent that synergistically work to scavenge chlorine in both the wash and rinse. These carry-over enhancers increase the amount of scavenger that survives the wash cycle allowing more of the chlorine in the rinse cycle to be scavenged. This can be measured directly through chlorine present in the rinse cycle, as well as decreased color fading on textiles. The combination of chlorine scavenger and carry-over enhancer agent provide rinse cycle benefits.

The chlorine scavenger agent includes non-polymeric nitrogen containing chlorine scavengers selected from hydroxyl-functional primary amines, hydroxyl-functional secondary amines and mixtures thereof wherein such hydroxyl-functional amines comprise from two to eight carbon atoms. Chlorine scavenger agents in this class include ethanolamines such as monoethanolamine (MEA, also known as 2-aminoethan-1-ol), diethanolamine (DEA, also known as 2,2′-iminodiethan-1-ol), triethanolamine (TEA, also known as 2,2′,2″-nitrilotriethan-1-ol); isopropanolamine; or a combination thereof.

Other non-limiting examples of non-polymeric nitrogen containing chlorine scavengers useful herein include: ammonia or ammonium salts such as ammonium nitrate, sulfate or carbonate, nonpolymeric amines, imines, amidines, acrylamides, and mixtures thereof. Suitable amines for example include 2-methyl pentamethylene diamine (MPMD), triethylene tetramine (TETA), dimethylamidopropylene (bis-DMAPA), diethylene triamine (DETA), and the like. Yet other nonpolymeric nitrogen containing chlorine scavengers include aminomethanephosphonic acid or its water soluble salts. Still other nonpolymeric nitrogen containing chlorine scavengers include amino acids (whether natural or synthetic) or their water-soluble salts, aminocarboxylic acids or their water-soluble salts, sulfamic acid or its water-soluble salts, or a combination thereof. A non-limiting example of a suitable amino acid or a water-soluble salt thereof is lysine.

In an embodiment, the chlorine scavenger agent is monoethanolamine, diethanolamine, isopropanolamine, triethanolamine, lysine, or a combination thereof. In an embodiment, the chlorine scavenger agent is monoethanolamine.

The chlorine scavenger agent can be present in the detergent composition in an amount of about 0.5% to about 10 wt % based on the total weight of the detergent composition, specifically about 1.0 to about 5 wt %, and more specifically about 1.2 to about 2.5 wt %.

The detergent composition further comprises a carry-over enhancer agent. Beyond just inclusion of ingredients that can scavenge chlorine, there is a synergistic effect between ingredients that deposit onto the fabric and carry over of chlorine scavengers from the wash cycle to the rinse cycle. For example, polymers that are often added to laundry compositions to help with anti-redeposition and soil-release, can survive the wash cycle into the rinse cycle and in doing so, increase the amount of chlorine scavenger carried into the rinse cycle.

Examples of suitable a carry-over enhancer agents include soil-release polymers, anti-redeposition polymers, cationic surfactants, cationic polymers, silicone-based polymers, or combination thereof.

The carry-over enhancer agent can be present in the detergent composition in an amount of about 0.1 to about 2 wt % based on the total weight of the detergent composition, specifically about 0.5 to about 1.9 wt %, and more specifically about 1.0 to about 1.8 wt %.

The carry-over enhancer agent can be a soil-release polymer. Suitable soil-release polymers include those disclosed in U.S. Publication No. 20190330565. Suitable soil release polymers include polyester-based soil release polymers, which generally comprise polymers of aromatic dicarboxylic acids and alkylene glycols (including polymers that additionally contain polyalkylene glycols). The polymeric soil release agents usable here include those soil release agents having (a) one or more nonionic hydrophilic components consisting essentially of (i) polyoxyethylene segments having a polymerization level of at least 2 or (ii) oxypropylene or polyoxypropylene segments having a polymerization level of 2 to 10, where the hydrophilic segment does not include any oxypropylene units, except when they are bonded via ether bonds to adjacent moieties at each end, or (iii) a mixture of oxyalkylene units comprising oxyethylene units and 1 to about 30 oxypropylene units, where the mixture contains a sufficiently great amount of oxyethylene units for the hydrophilic component to be hydrophilic enough to increase the hydrophilicity of conventional synthetic polyester fiber surfaces on deposition of the soil release agent on such a surface, where the hydrophilic segments contain at least 25% oxyethylene units and more specifically, especially for those components having about 20 to 30 oxypropylene units, at least about 50% oxyethylene units; (b) one or more hydrophobic components comprising: (i) C₃-oxyalkylene terephthalate segments where, when the hydrophobic components also include oxyethylene terephthalate, the ratio of oxyethylene terephthalate to C₃-oxyalkylene terephthalate units is about 2:1 or less, (ii) C₄-C₆-alkylene or oxy-C₄-C₆-alkylene segments or a combination thereof, (iii) polyvinyl ester segments, specifically polyvinyl acetate, with a polymerization level of at least 2 or (iv) C₁-C₄-alkyl ether or C₄-hydroxyalkyl ether substituents or a combination thereof, where the substituents are in the form of C₁-C₄-alkyl ether or C₄-hydroxyalkyl ether cellulose derivatives or mixtures thereof and cellulose derivatives of this kind are amphiphilic, where they have a sufficient content of C₁-C₄-alkyl ether and/or C₄-hydroxyalkyl ether units to be deposited on conventional synthetic polyester fiber surfaces and, after adhering on a conventional synthetic fiber surface of this kind, retain a sufficient content of hydroxyl groups to increase the hydrophilicity of the fiber surface, or a combination of (a) and (b).

Typically, the polyoxyethylene segments of (a)(i) have a polymerization level of about 1 to about 200, although it is also possible to use higher levels, specifically of 3 to about 150 and more specifically of 6 to about 100.

A particular soil-release polymer is a polyester having repeat units formed from alkylene terephthalate units, containing 10%-30% by weight of alkylene terephthalate units together with 90%-70% by weight of polyoxyethylene terephthalate units which derive from a polyoxyethylene glycol having a mean molecular weight of 300-8000.

In one embodiment, the soil-release polymer is a (1) polyester polymer based on terephthalic acid and propylene glycol with a molecular weight of less than 4000 g/mol. In some of those embodiments, the polyester polymers are polyesters based on terephthalic acid and 1,2-propylene glycol endcapped with methoxy PEG 750 and a molecular weight of about 2700 g/mol.

In another embodiment, the soil-release polymer is a (2) polyester polymer based on terephthalic acid and propylene glycol with a molecular weight of equal to or more than 4000 g/mol. In some of those embodiments, the polyester polymers are polyesters based on terephthalic acid and 1,2-propylene glycol endcapped with methoxy PEG 2000 and a molecular weight M w of about 6200 g/mol.

In an embodiment, the soil-release polymer is an acrylate copolymer, a comb or block copolymer, nonionic polypropylene terephthalate polyester, or a combination thereof.

In an embodiment, the soil-release polymer is a nonionic polypropylene terephthalate polyester.

The carry-over enhancer agent can be an anti-redeposition polymer.

In an embodiment, the anti-redeposition polymer is a polyacrylate, a polymethylacrylate, a methylacrylate, an acrylate copolymer, a styrene copolymer, a sodium methylacrylate styrene copolymer, a sulfonated condensate of phenol and formaldehyde, a comb or block copolymer, ethylene glycol polymer or copolymer, propylene glycol polymer or copolymer, or a combination thereof.

Suitable anti-redeposition polymers are described in US20210238501A1. These include polyacrylate, polymethylacrylate, methylacrylate styrene copolymers, sodium methylacrylate styrene copolymers, homopolymers of acrylic acid, and the like, or a combination thereof.

Suitable acrylate copolymers that function as anti-redeposition polymers are described in WO2013060706A1. Suitable comb or block copolymers that function as anti-redeposition polymers are described in WO2013060708A1. Suitable sulfonated condensates of phenol and formaldehyde that function as anti-redeposition polymers are described in WO2015091174A1.

Suitable ethylene glycol or propylene glycol polymers or copolymers that function as anti-redeposition polymers are described in WO2018114451A1. In an embodiment, the polyethylene glycol polymer has a number average molecular weight in the range from 300 grams (g)/mol to 35000 g/mol. In the copolymers, the weight ratio of propylene glycol to ethylene glycol in the copolymers is in the range of 10:90 to 90:10, specifically 60:40 to 80:20. In the copolymers, the monomers may be randomized or present as blocks. Certain copolymers include polyethylene glycol blocks fused to a central polypropylene glycol block. In these, the molecular weight of the central polypropylene glycol block is in the range of 1000 g/mol to 5000 g/mol, and the molecular weight of each polyethylene glycol block bonded thereto is in the range of 100 g/mol to 6000 g/mol.

The carry-over enhancer agent can be a cationic surfactant. Suitable cationic surfactants include, for example, quaternary ammonium surfactants. Suitable cationic surfactants include, for example, those having the formulas below:

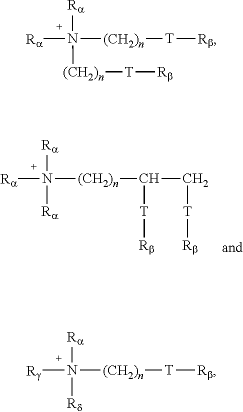

wherein each radical R_{α} is independent of the others C₁₋₆-alkyl-, -alkenyl- or -hydroxyalkyl; each radical R_{β} is independent of the others C₈₋₂₈-alkyl- or alkenyl; R_{γ} is R_{α} or (CH₂)ₙ-T-R_{β}; R_{δ} is R_{α} or R_{β} or (CH₂)ₙ-T-R_{β}; T=—CH₂—, —O—CO— or —CO—O— and n is between 0 and 5.

Other suitable quaternary ammonium surfactants include mono C₆-C₁₆, or C₆-C₁₀ N-alkyl or alkenyl ammonium surfactants, wherein the remaining N positions are substituted by, e.g., methyl, hydroxyethyl or hydroxypropyl groups. Another cationic surfactant is C₆-C₁₈alkyl or alkenyl ester of a quaternary ammonium alcohol, such as quaternary chlorine esters. In another embodiment, the cationic surfactants have the following formula (I)

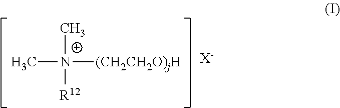

wherein R¹² is C₈-C₁₈ hydrocarbyl and mixtures thereof, or C₈₋₁₄ alkyl, or C₈, C₁₀, or C₁₂ alkyl, X is an anion such as chloride or bromide, and j is a positive integer.

In an embodiment, the cationic surfactant is an alkylammonium, specifically a hydroxyalkyl-trialkyl-ammonium compound, and more specifically a C₁₂₋₁₈ alkyl(hydroxy-ethyl)dimethylammonium compound, and the corresponding chloride salt thereof.

The carry-over enhancer agent can be a silicone-based polymer. Suitable silicone-based polymers include, for example, cyclic silicones, polydialkylsiloxanes, aminosilicones (e.g., an aminofunctional silicone, amino-polyether silicone), alkyloxylated silicones (e.g., ethoxylated silicone, propoxylated silicone, ethoxylated/propoxylated silicone), cationic silicones, silicone polyethers, silicone resins, silicone urethanes, quaternary silicone, random or blocky organosilicone polymers, or a combination thereof. In an embodiment, the silicone-based polymer is a polydialkylsilicone, such as a polydimethyl silicone (e.g., polydimethyl siloxane or “PDMS”), or a derivative thereof.

The detergent composition further comprises an anionic surfactant. Suitable anionic surfactants include, but are not limited to, those surfactants that contain a long chain hydrocarbon hydrophobic group in their molecular structure and a hydrophilic group, i.e., water solubilizing group including salts such as carboxylate, sulfonate, sulfate, or phosphate groups. Suitable anionic surfactant salts include sodium, potassium, calcium, magnesium, barium, iron, ammonium, and amine salts.

Anionic surfactants include an alkyl ether sulfate also referred to alcohol ethoxy sulfates (AES). The alkyl-ether sulfates will generally be used in the form of mixtures comprising varying R′ chain lengths and varying degrees of ethoxylation. The heterogeneity of chain length may be due to the sourcing of the material and/or the processing of the material. Frequently such mixtures will inevitably also contain some unethoxylated alkyl sulfate materials, i.e., surfactants of the below ethoxylated alkyl sulfate formula (I) wherein n=0. Unethoxylated alkyl sulfates may also be added separately to the compositions. Suitable unalkoxylated, e.g., unethoxylated, alkyl-ether sulfate surfactants are those produced by the sulfation of higher C₈-C₂₀ fatty alcohols. Conventional primary alkyl sulfate surfactants have the general formula of: ROSO₃M, wherein R is typically a linear C₈-C₂₀hydrocarbyl group, which may be straight chain or branched chain, and M is a water-solubilizing cation; specifically, R is a C₁₀-C₁₅ alkyl, and M is alkali metal. In one embodiment, R is C₁₂-C₁₄ and M is sodium. In one embodiment, the AES corresponds to the following formula (II):

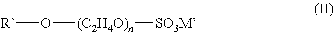

wherein R′ is a C₈-C₂₀ alkyl group, n is from 1 to 20, and M′ is a salt-forming cation; specifically, R′ is C₁₀-C₁₈ alkyl, n is from 1 to 15, and M′ is sodium, potassium, ammonium, alkylammonium, or alkanolammonium. In an embodiment, R′ is a C₁₂-C₁₆ alkyl, n is from 1 to 6 and M′ is sodium. In a further embodiment, the alkyl-ether sulfate has a C₁₂ alkyl chain, for example, sodium lauryl ether sulphate (SLES).

In an embodiment, the detergent composition contains AES in an amount of about 1 to about 30 wt %, specifically about 2 wt % to about 20 wt %, more specifically about 5 wt % to about 10 wt %, based on the total weight of the detergent composition.

The anionic surfactant may include a water-soluble salt of an alkyl benzene sulfonate having between 8 and 22 carbon atoms in the alkyl group. In one embodiment, the anionic surfactant comprises an alkali metal salt of C₁₀₋₁₆alkyl benzene sulfonic acids, such as C₁₁₋₁₄ alkyl benzene sulfonic acids. In one embodiment, the alkyl group is linear and such linear alkyl benzene sulfonates are known in the art as “LAS.” An exemplary LAS is 2-phenyl sulfonic acid, also referred to as 2-dodecylbenzenesulfonic acid.

In certain embodiments, LAS may be present in the detergent composition at about 0.5 to about 15 wt % based on the total weight of the detergent composition, specifically about 1 to about 12 wt %, and more specifically about 2 to about 10 wt %. In certain embodiments, the LAS is 2-dodecylbenzenesulfonic acid.

Other suitable anionic surfactants include sodium and potassium linear, straight chain alkylbenzene sulfonates in which the average number of carbon atoms in the alkyl group is between 11 and 14. Sodium C₁₄-C₁₄, e.g., C₁₂ LAS are exemplary of suitable anionic surfactants for use herein.

In one embodiment, the anionic surfactant includes at least one α-sulfofatty acid ester. Such a sulfofatty acid is typically formed by esterifying a carboxylic add with an alkanol and then sulfonating the α-position of the resulting ester. The α-sulfofatty add ester is typically of the following formula (III):

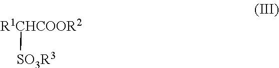

wherein R¹ is a linear or branched alkyl, R² is a linear or branched alkyl, and R³ is hydrogen, a halogen, a mono-valent or di-valent cation, or an unsubstituted or substituted ammonium cation. R¹ can be a C₄ to C₂₄ alkyl, including a C₁₀, C₁₂, C₁₄, C₁₆ and/or C₁₈alkyl. R² can be a C₁ to C₈ alkyl, including a methyl group. R³ is typically a mono-valent or di-valent cation, such as a cation that forms a water-soluble salt with the α-sulfofatty acid ester (e.g., an alkali metal salt such as sodium, potassium or lithium). The α-sulfofatty acid ester of formula (III) can be a methyl ester sulfonate, such as a C₁₆ methyl ester sulfonate, a C₁₈ methyl ester sulfonate, or a mixture thereof. In another embodiment, the α-sulfofatty acid ester of formula (III) can be a methyl ester sulfonate, such as a mixture of C₁₂-C₁₈ methyl ester sulfonates.

More typically, the α-sulfofatty acid ester is a salt, such as a salt according to the following formula (IV):

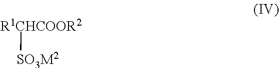

wherein R¹ and R² are linear or branched alkyls and M² is a monovalent metal. R¹ can be a C₄ to C₂₄alkyl, including a C₁₀, C₁₂, C₁₄, C₁₆, and/or C₁₈ alkyl. R² can be a C₁ to C₈ alkyl, including a methyl group, M² is typically an alkali metal, such as sodium or potassium. The α-sulfofatty acid ester of formula (IV) can be a sodium methyl ester sulfonate, such as a sodium C₈-C₁₈ methyl ester sulfonate.

Suitable anionic surfactants include, for example, alkylbenzene sulfonic acids, alkyl ether sulfates, polyethoxylated alcohol sulfates, sodium lauryl ether sulfates, alkali metal salts of C₁₀-C₁₆alkyl benzene sulfonic acids, linear alkyl benzene sulfonates, sodium and potassium linear, straight chain alkylbenzene sulfonates, α-sulfofatty acid esters, ethoxysulfates, such as, for example, C₁₂-C₁₅ ethoxysulfate (alcohol ethoxysulfate) 3EO, or a combination thereof.

In an embodiment, the anionic surfactant is an alkylbenzene sulfonic acid, an alkyl ether sulfate, a polyethoxylated alcohol sulfate, a sodium lauryl ether sulfate, an alkali metal salt of a C₁₀-C₁₆ alkyl benzene sulfonic acid, a linear alkyl benzene sulfonate, a sodium or potassium straight chain alkylbenzene sulfonate, an α-sulfofatty acid ester, an ethoxysulfate, or a combination thereof.

In an embodiment, the anionic surfactant is a sodium laureth sulfate, a linear alkylbenzene sulfonic acid, or a combination thereof. In an embodiment, the anionic surfactant is a combination of a sodium laureth sulfate and a linear alkylbenzene sulfonic acid.

The anionic surfactant can be present in the detergent composition in an amount of 5.0 to about 30 wt % based on the total weight of the detergent composition, specifically about 6.0 to about 25 wt %, and more specifically about 7.0 to about 20 wt %.

The detergent composition can further include one or more additional ingredient, for example, a builder, a nonionic surfactant, a chelant, a foam inhibitor, an optical brightener, an enzyme, a colorant, a fragrance, an organic solvent, a preservative, an antioxidant, or a combination thereof.

The detergent composition can further include a builder. Suitable builders include citrates, carbonates, silicates, aluminosilicates (zeolite), phosphonates, polyphosphonates, bicarbonates, borates, polycarboxylates, or a combination thereof. Citrate builders, e.g., citric acid and soluble salts thereof (e.g. sodium salt), are suitable water-soluble organic builders. Citrates can be used in combination with zeolite or silicates. The builder can be any chelating agent that forms water-soluble complexes with Ca and M g. N on-limiting examples of builders include zeolites, including zeolite A or P or X, carbonates such as sodium carbonate, soluble silicates such as sodium metasilicate, layered silicates (e.g., SKS-6 from Hoechst), and (carboxymethyl)inulin (CMI), or a combination thereof. Further non-limiting examples of suitable builders include aminocarboxylates, aminopolycarboxylates, and alkyl- or alkenylsuccinic acid. Specific examples include 2,2′,2″-nitrilotriacetic acid (NTA), ethylenediaminetetraacetic acid (EDTA), diethylenetriaminepentaacetic acid (DTPA), iminodisuccinic acid (IDS or IDA), ethylenediamine-N,N′-disuccinic acid (EDDS), methylglycine-N,N-diacetic acid (MGDA), glutamic acid-N,N-diacetic acid (GLDA), 1-hydroxyethane-1,1-diphosphonic acid, N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), N-(sulfomethyl)aspartic acid (SMAS), N-(2-sulfoethyl)-aspartic acid (SEAS), N-(sulfomethylglutamic acid (SMGL), N-(2-sulfoethyl)-glutamic acid (SEGL), N-methyliminodiacetic acid (MIDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and N′-(2-hydroxyethyl)ethylenediamine-N,N,N′-triacetic acid (HEDTA), diethanolglycine (DEG), a salt thereof or a combination thereof. Phosphonates suitable for use herein include 1-hydroxyethane-1,1-diphosphonic acid (HEDP), ethylenediaminetetrakis (methylenephosphonic acid) (EDTMPA), diethylenetriaminepentakis (methylenephosphonic acid) (DTMPA or DTPMPA or DTPMP), nitrilotris (methylenephosphonic acid) (ATMP or NTMP), 2-phosphonobutane-1,2,4-tricarboxylic acid (PBTC), hexamethylenediaminetetrakis (methylenephosphonic acid) (HDTMP).

In an embodiment, the builder is alkali metal hydroxide such as sodium hydroxide, boric acid, and the like.

Builders can be present in the detergent composition in an amount of about 2.5 to about 7.5 wt % based on the total weight of the detergent composition.

The detergent composition can further include a chelant/chelator. Chelants may functionally overlap with builders as discussed above. Chelants are often polycarboxylic acids or a salt thereof. Polyamines, aminocarboxylates, aminopolycarboxylates, and alkyl- or alkenylsuccinic acid are also used. Suitable examples of chelants include citric acid, succinic acid, 2,2′,2″-nitrilotriacetic acid (NTA), ethylenediaminetetraacetic acid (EDTA), diethylenetriaminepentaacetic acid (DTPA), iminodisuccinic acid (IDS or IDA), ethylenediamine-N,N′-disuccinic acid (EDDS), methylglycine-N,N-diacetic acid (MGDA), glutamic acid-N,N-diacetic acid (GLDA), 1-hydroxyethane-1,1-diphosphonic acid, N-(2-hydroxyethyl)iminodiacetic acid (EDG), aspartic acid-N-monoacetic acid (ASM A), aspartic acid-N,N-diacetic acid (ASDA), aspartic acid-N-monopropionic acid (ASMP), N-(sulfomethyl)aspartic acid (SMAS), N-(2-sulfoethyl)-aspartic acid (SEAS), N-(sulfomethylglutamic acid (SM GL), N-(2-sulfoethyl)-glutamic acid (SEGL), N-methyliminodiacetic acid (M IDA), serine-N,N-diacetic acid (SEDA), isoserine-N,N-diacetic acid (ISDA), phenylalanine-N,N-diacetic acid (PH DA), anthranilic acid-N,N-diacetic acid (AN DA), sulfanilic acid-N,N-diacetic acid (SLDA), taurine-N,N-diacetic acid (TUDA) and N′-(2-hydroxyethyl)ethylenediamine-N,N,N′-triacetic acid (HEDTA), diethanolglycine (DEG), a salt thereof or a combination thereof. Phosphonates suitable for use herein include 1-hydroxyethane-1,1-diphosphonic acid (HEDP), ethylenediaminetetrakis (methylenephosphonic acid) (EDTMPA), diethylenetriaminepentakis (methylenephosphonic acid) (DTMPA or DTPMPA or DTPMP), nitrilotris (methylenephosphonic acid) (ATMP or NTMP), 2-phosphonobutane-1,2,4-tricarboxylic acid (PBTC), hexamethylenediaminetetrakis (methylenephosphonic acid) (HDTMP). In an embodiment, the chelant is citric acid, iminodisuccinic acid, methylglycine-N,N-diacetic acid, glutamic acid-N,N-diacetic acid, a salt thereof, or a combination thereof.

The chelant can be present in the detergent composition in an amount of about 0 to about 7.5 wt % based on the total weight of the detergent composition, specifically about 1.0 to about 5.0 wt %.

The detergent composition can further include a foam inhibitor. Suitable foam inhibitors include, for example, a fatty acid, a fatty alcohol, a combination thereof and the like.

The foam inhibitor can be present in the detergent composition in an amount of about 0 to about 5.0 wt % based on the total weight of the detergent composition, specifically about 0.5 to about 3.5 wt %.

In an embodiment, the detergent composition does not contain a colorant.

In another embodiment, the detergent composition contains a colorant. The colorant can be, a polymer, or a dye, or a combination thereof, specifically a water-soluble polymeric colorant, a water-soluble dye, or a combination thereof. The colorant can be, for example, those colorants that are well-known in the art or commercially available from dye or chemical manufacturers. The color of the colorant(s) is not limited.

The colorant may provide a secondary indicator of source for a user. The colorant may provide aesthetic or informational value. For example, the color of the detergent composition may be used to indicate a preferred water temperature (e.g., red for hot, blue for cold).

The colorant may be present in the detergent composition in an amount of about 0.00001 wt % to about 0.099 wt %, specifically about 0.0001 wt %, about 0.001 wt %, about 0.01 wt %, about 0.05 wt %, or about 0.08 wt % based on the total weight of the detergent composition.

In an embodiment, the detergent composition does not contain a fragrance or perfume.

In another embodiment, the detergent composition contains a fragrance or perfume. The fragrance can include any fragrant substance or mixture of substances including natural (obtained by extraction of flowers, herbs, leaves, roots, barks, wood, blossoms or plants), artificial (mixture of natural oils or oil constituents) and synthetically produced odoriferous substances. Typically, fragrances and perfumes are complex mixtures of blends of various organic compounds such as alcohols, aldehydes, ethers, aromatic compounds and varying amounts of essential oils (e.g., terpenes) such as from 0 wt % to 80 wt %, usually from 1 wt % to 70 wt %, the essential oils themselves being volatile odoriferous compounds and also serving to dissolve the other components of the fragrance. The fragrance may be present in the detergent composition in an amount of about 0.1 wt % to about 10 wt %, and specifically about 0.5 wt % to about 5 wt % based on the total weight of the detergent composition.

The detergent composition can further include a nonionic surfactant. Suitable nonionic surfactants include alkoxylated fatty alcohols, ethylene oxide (EO)-propylene oxide (PO) block polymers, amine oxide surfactants, alcohol alkoxylates, C₂-C₁₅ alcohol ethoxylates, ethoxylated or ethoxylated and propoxylated, fatty acid alkyl esters, polyalkoxylated alkanolamides, polyoxyalkylene alkyl ethers, polyoxyalkylene alkylphenyl ethers, polyoxyalkylene sorbitan fatty acid esters, polyoxyalkylene sorbitol fatty acid esters, polyalkylene glycol fatty acid esters, alkyl polyalkylene glycol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, alkylamine oxides, or a combination thereof.

Suitable nonionic surfactants include, for example, alkoxylated fatty alcohols, ethylene oxide (EO)-propylene oxide (PO) block polymers, and amine oxide surfactants. Suitable for use in the compositions herein are those nonionic surfactants which are normally liquid. Suitable nonionic surfactants for use herein include the alcohol alkoxylated nonionic surfactants. Alcohol alkoxylates are materials which correspond to the general formula of: R⁹(CₘH₂ₘO)_{b}OH, wherein R⁹ is a linear or branched C₈-C₁₆ alkyl group, m is from 2 to 4, and b ranges from 2 to 12: alternatively, R⁹ is a linear or branched C₉₋₁₅ or C₁₀₋₁₄alkyl group. In another embodiment, the alkoxylated fatty alcohols will be ethoxylated materials that contain from 2 to 12, or 3 to 10, ethylene oxide (EO) moieties per molecule. The alkoxylated fatty alcohol materials useful in the compositions herein will frequently have a hydrophilic-lipophilic balance (HLB) which ranges from 3 to 17, from 6 to 15, or from 8 to 15. Another nonionic surfactant suitable for use includes ethylene oxide (EO)-propylene oxide (PO) block polymers. These materials are formed by adding blocks of ethylene oxide moieties to the ends of polypropylene glycol chains to adjust the surface active properties of the resulting block polymers. In one embodiment, the nonionic surfactant is C₁₂-C₁₅ alcohol ethoxylate 7EO, that is to say having seven ethylene oxide moieties per molecule. The fatty alcohol ethoxylate may have 3 to 17 moles of ethylene oxide units per mole of fatty alcohol ethoxylate.

Another embodiment of a nonionic surfactant is alkoxylated, specifically ethoxylated or ethoxylated and propoxylated fatty acid alkyl esters, having from 1 to 4 carbon atoms in the alkyl chain, especially fatty acid methyl esters. In one embodiment, the nonionic surfactant is methyl ester ethoxylate.

Suitable nonionic surfactants also include polyalkoxylated alkanolamides, which are generally of the following formula (V):

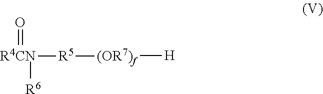

wherein R⁴ is an alkyl or alkoxy, R⁵ and R⁷ are alkyls and f is a positive integer. R⁴ is typically an alkyl containing 6 to 22 carbon atoms. R⁵ is typically an alkyl containing 1-8 carbon atoms. R⁷ is typically an alkyl containing 1 to 4 carbon atoms, and more typically an ethyl group. The degree of polyalkoxylation (the molar ratio of the oxyalkyl groups per mole of alkanolamide) typically ranges from about 1 to about 100, or from about 3 to about 8, or about 5 to about 6. R⁶ can be hydrogen, an alkyl, an alkoxy group or a polyalkoxylated alkyl. The polyalkoxylated alkanolamide is typically a polyalkoxylated mono- or di-alkanolamide, such as a C₁₆ and/or C₁₈ ethoxylated monoalkanolamide, or an ethoxylated monoalkanolamide prepared from palm kernel oil or coconut oil. The use of coconut oil, palm oil, and similar naturally occurring oils as precursors may be favored by consumers.

Other suitable nonionic surfactants include those containing an organic hydrophobic group and a hydrophilic group that is a reaction product of a solubilizing group (such as a carboxylate, hydroxyl, amide or amino group) with an alkylating agent, such as ethylene oxide, propylene oxide, or a polyhydration product thereof (such as polyethylene glycol). Such nonionic surfactants include, for example, polyoxyalkylene alkyl ethers, polyoxyalkylene alkylphenyl ethers, polyoxyalkylene sorbitan fatty acid esters, polyoxyalkylene sorbitol fatty acid esters, polyalkylene glycol fatty acid esters, alkyl polyalkylene glycol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, and alkylarnine oxides.

Yet another nonionic surfactant useful herein comprises amine oxide surfactants. Amine oxides are often referred to in the art as “semi-polar” nonionics, and have the following formula (VI):

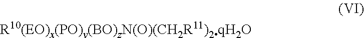

wherein R¹⁰ is a hydrocarbyl moiety which can be saturated or unsaturated, linear or branched, and can typically contain from 8 to 24, from 10 to 16 carbon atoms, or a C₁₂-C₁₆ primary alkyl. R¹¹ is a short-chain moiety such as a hydrogen, methyl and —CH₂OH. When x+y+z is greater than 0, EO is ethyleneoxy, PO is propyleneoxy and BO is butyleneoxy. In this formula, q is the number of water molecules in the surfactant. In one embodiment, the nonionic surfactant is C₂₋₁₄ alkyldimethyl amine oxide.

In an embodiment, the nonionic surfactant is a fatty alcohol ethoxylate.

The nonionic surfactant can be present in the detergent composition in an amount of about 0.5 to about 20 wt % based on the total weight of the detergent composition, specifically about 4.0 to about 15 wt %, and more specifically about 5 to about 10 wt %.

The detergent composition can further include an optical brightener or whitening agent, which help washed material appear white, especially under florescent light. Optical brighteners may be complex, polycyclic molecules. The most commonly used optical brighteners are those belonging to the classes of diaminostilbene-sulfonic acid derivatives, diarylpyrazoline derivatives, and bisphenyl-distyryl derivatives. In an embodiment, the optical brightener is the disodium salt of 4,4′-bis-(2-morpholino-4-anilino-s-triazin-6-ylamino) stilbene-2,2′-disulfonate, the disodium salt of 2,2′-bis-(phenyl-styryl)-disulfonate, 4,4′-diamino-2,2′-stilbenedisulfonic acid, or 2,5-bis(benzoxazol-2-yl)thiophene.

The optical brightener can be present in the detergent composition in an amount of about 0.025 to about 5 wt % based on the total weight of the detergent composition, specifically specifically about 0.1 to about 3 wt %, and more specifically about 0.2 to about 2 wt %.

The detergent composition can further include an enzyme. Suitable enzymes include those known in the art, such as amylases, catalases, cellulases, cutinases, lipases, mannanases, pectinases, peroxidases, proteases, or a combination thereof. Enzymes maybe provided with other components, including stabilizers.

The enzyme can be present in the detergent composition in an amount of about 0.25 to about 10 wt % based on the total weight of the detergent composition, specifically about 0.5 to about 5.0 wt %, and more specifically about 1.0 to about 3.0 wt % of active enzymes.

The detergent composition can further include an organic solvent such as an alcohol, for example polyethylene glycol; glycerol; propylene glycol; ethylene glycol; ethanol; polypropylene glycol; polyethylene glycol esters such as polyethylene glycol stearate, propylene glycol laurate, and propylene glycol palmitate; methyl ester ethoxylate; diethylene glycol; dipropylene glycol; butylene glycol; pentanediol; hexylene glycol; heptylene glycol; octylene glycol; 2-methyl, 1,3 propanediol; triethylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; or a combination thereof.

In an embodiment, the detergent composition comprises a glycol, and more specifically propylene glycol, dipropylene glycol, or a combination thereof.

The detergent composition can include an organic solvent in an amount of about 1 to about 30 wt % based on the total weight of the detergent composition.

The detergent composition comprises water in an amount of at least 30 wt % based on the total weight of the detergent composition. In certain embodiments, water content can be about 30 to about 70%. The weight percent of the total water in the liquid detergent composition is calculated based on all the water including those added as a part of individual ingredients. When an ingredient added to make the liquid composition is not 100% pure and used as a mixture, e.g., in a form of a solution, the wt % of that material added refers to the weight percentage of the mixture. Thus, a component which is 5 wt % of the formulation, may be added as 5 wt % of a pure component or 10 wt % of solution that is 50% component and 50% water. Either result produces the recited 5 wt % amount of the component in the resulting composition.

In various embodiments, the detergent composition is an aqueous liquid detergent composition comprising water. In certain embodiments, the water is present in an amount of at least 30 wt % and up to about 70 wt % based on the total weight of the detergent composition, specifically about 35 wt % to about 60 wt %, more specifically about 40 wt % to about 50 wt %.

The detergent compositions described herein are free of dye transfer inhibitor agents, meaning they contain no amount of dye transfer inhibitor agent. Dye transfer inhibitor agents are polymeric materials are known in the art for reducing or preventing dye-transfer during the laundering process. Dye transfer inhibitor agents include polyvinylpyrrolidone (“PVP”, poly-N-vinylpyrrolidone) and copolymers thereof, including the copolymer of N-vinylpyrrolidone and N-vinylimidazole (also abbreviated as “PVPVI” or “PVP/PVI”). These agents include copolymers of N-vinylimidazole and N-vinylpyrrolidone (aka N-vinyl-2-pyrolidone). A further dye transfer inhibitor agent is poly-4-vinylpyridine N-oxide (PV NO).

The detergent compositions described herein are useful in cleaning processes, including laundry/textile/fabric cleaning processes, both household laundry washing and industrial laundry washing. “Laundry washing” and “laundering” relate to both household laundering and industrial laundering and means the process of treating textiles with a solution containing a detergent composition described herein. The laundering process can be, for example, carried out using a household or an industrial washing machine or can be carried out by hand.

Further disclosed herein is a method of enhancing the chlorine scavenging ability of a detergent composition in a laundry rinse cycle, comprising administering a detergent composition as described herein in a wash cycle of a laundry washing process comprising a wash cycle followed by a rinse cycle.

Disclosed herein is a method for cleaning or laundering an item comprising exposing an item or a wash liquor to a detergent composition as described herein comprising anionic surfactant, chlorine scavenging agent, carry-over enhancer agent, and water, the detergent composition being free of a dye transfer inhibitor agent; completing at least one wash cycle; and rinsing the item, wherein the item is a fabric.

The following example are merely illustrative of the detergent compositions disclosed herein and are not intended to limit the scope thereof.

### EXAMPLES

All compositions described below are given in % weight of each material included in the formula.

### Example 1

Below tables include inventive formulas based on Chassis 1-3 and comparative (control) formulas.

TABLE 1

| | Raw Material | Ballast | Wt % of | Wt % of |
|---|---|---|---|---|
| Component | Activity (%) | Blank | Chassis 1 | Chassis 2 |
| Water, demineralized | 100 | 100% | q/s to 100% | q/s to 100% |
| Builders (Sodium | 50 | 0% | 2.5-7.5% | 2.5-7.5% |
| Hydroxide, Boric Acid) | | | | |
| Fatty alcohol ethoxylate | 100 | 0% | 10.9% | 4.5% |
| (C12-C15, 7 EO) | | | | |
| Anionic surfactant (Sodium | 70 | 0% | 20.2% | 19.9% |
| Laureth Sulfate, 3EO; | | | | |
| Linear Alkylbenzene | | | | |
| sulfonic acid) | | | | |
| Fatty Acid | 100 | 0% | 0.5% | 0.5% |
| Monoethanolamine | 100 | 0% | 1.2-2.5% | 1.2-2.5% |
| Citric Acid | 50 | 0% | 0-5% | 0-5% |
| Misc. Propylene Glycol, | N/A | 0% | 0-26% | 0-26% |
| Chelant, Optical | | | | |
| Brightener, Aqueous | | | | |
| Enzyme Solution (one or | | | | |
| some of Protease, Amylase, | | | | |
| Mannanase, Cellulase | | | | |
| blend), Colorant, Fragrance | | | | |
| Carry-over enhancer (e.g., | 100 | 0% | 0.1-1.5% | 0.1-1.5% |
| Soil-release polymer, anti- | | | | |
| redeposition polymer, | | | | |
| cationic surfactants) | | | | |

TABLE 2

| | Raw | | |
|---|---|---|---|
| | Material | | |
| | Activity | Wt % of | Neutral |
| Component | (%) | Chassis 3 | Sensitive |
| Water, demineralized | 100 | q/s to 100 | q/s to 100 |
| Builders (Sodium Hydroxide, | 50 | 2.5-7.5% | 2.5-7.5% |
| Boric Acid) | | | |
| Fatty alcohol ethoxylate | 100 | 0.9% | 10.9% |
| (C12-C15, 7 EO) | | | |
| Anionic surfactant (Sodium | 70 | 16.4% | 5.5% |
| Laureth Sulfate, 3EO; Linear | | | |
| Alkylbenzene sulfonic acid) | | | |
| Fatty Acid | 100 | 0.5% | 0.5% |
| Monoethanolamine | 100 | 1.2-2.5% | 1.2-2.5% |
| Citric Acid | 50 | 0-5% | 0-5% |
| Misc. Propylene Glycol, | N/A | 0-26% | 0-26% |
| Chelant, Optical Brightener, | | | |
| Aqueous Enzyme Solution | | | |
| (one or some of Protease, | | | |
| Amylase, Mannanase, | | | |
| Cellulase blend), Colorant, | | | |
| Fragrance | | | |
| Carry-over enhancer (Soil- | 100 | 0.1-1.5% | 0.1-1.5% |
| release polymer, anti- | | | |
| redeposition polymer, cationic | | | |
| surfactants) | | | |

### Example 2

Screening of materials able to scavenge chlorine a) in the wash and b) carry-over to the rinse cycle was conducted by using chlorine test strips. This screening identified the pool of raw materials with potential to scavenge chlorine in the rinse, with some dual compositions screened (LAS+MEA, MEA+citric acid, LAS+lysine for example). Inclusion levels and results were identified for a singular dose size representing current commercial products.

Test method 1: A wash cycle was conducted using the detergents described in Example 1 containing soil-release polymer with trade name SRN 170 (polypropylene terephthalate polyester Soil release polymer) as the carry-over enhancer agent. The dose of detergent is indicated in Table 3A and the target dose of detergent per wash for Table 3B was 45 grams. The estimated amount of water in the Speed Queen AWN412 Standard Top Loader washing machine was 62.5 L for the wash cycle and 62.5 L for the rinse cycle. The starting chlorine concentration for both the wash and rinse cycle, respectively, was 1 ppm. A warm wash at ˜32° C. was conducted for 12 minutes, followed by a subsequent rinse cycle at 15° C. for 3 minutes. A bout 2.5 kg of cotton ballast was used for the evaluation. The chlorine level was measured 3 minutes into each cycle using an Insta-Test strip (chlorine indicator strips), which was submerged into the wash/rinse liquor to collect a ppm level of free chlorine present.

The chlorine scavenging effects of common commercial products and the inventive formulas are shown in below tables. In the tables, LAS represents linear alkylbenzene sulfonic acid-based surfactant; NI represents nonionic surfactant; and SLES represents sodium laureth sulfate surfactant. As observed in Tables 3A-3B, the inventive detergents Chassis 1-3 containing soil release polymer scavenge all hypochlorite in both the wash and rinse step, whereas the commercial detergents scavenge hypochlorite in the wash step only. Certain materials like soil-release polymers deposit on fabric, typically in sub-monolayer concentrations and were only thought to interact with the fabric surface. The ability of the carryover enhancer alone, without a secondary polymer, to interact with chlorine scavengers and increase retention on the fabric such that they can even survive the wash cycle is a surprising effect of the present invention.

TABLE 3A
FABRIC CARE CHASSIS TO OPTIMIZE RINSE CARRY-OVER

| | | | | Hypochlorite | Hypochlorite |
|---|---|---|---|---|---|
| | | | | in Wash | in Rinse |
| | | | | After 1 | After 3 |
| | | | | Minute | Minutes |
| Detergent | Dose (g) | Anionic? | MEA? | (ppm) | (ppm) |
| Commercial | 44.81 g | LAS + SLES | Yes | 0 | 0.5 |
| Product 1 | | | | | |
| Commercial | 45.53 g | LAS | No | 0 | 0.5 |
| Product 2 | | | | | |
| Commercial | 30.66 g | LAS + SLES | No | 0 | 1 |
| Product 3 | | | | | |
| Commercial | 39.45 g | LAS + SLES | No | 0 | 1 |
| Product 4 | | | | | |
| Commercial | 43.37 g | LAS + SLES | No | 0 | 0.5 |
| Product 5 | | | | | |

TABLE 3B

| | | | | | Hypochlorite | Hypochlorite |
|---|---|---|---|---|---|---|
| | | | | | in Wash | in Rinse |
| | | LAS(g) | Total | | After 1 | After 3 |
| Chassis | | per | Active | MEA (g) | Minute | Minutes |
| Type | LAS:NI:SLES | dose | Surfactant | per dose | (ppm) | (ppm) |
| Ballast | — | — | — | — | 0.5 | 1 |
| Blank | | | | | | |
| Chassis | 0.5:0.35:0.15 | 5.95 g | 29% | 0.5-1 g | 0 | 0 |
| 1 | | | | | | |
| Chassis | 0.7:0.2:0.1 | 5.95 g | 22.4% | 0.5-1 g | 0 | 0-0.5 → 0 |
| 2 | | | | | | |
| Chassis | 0.9:0.05:0.05 | 5.95 g | 16.4% | 0.5-1 g | 0 | 0 |
| 3 | | | | | | |
| Neutral | 0:0.33:0.67 | 0 g | 16.4% | 0.5-1 g | 0 | 0.5 → 0-0.5 |
| Sensitive | | | | | | |
| Chassis | 0.5:0.35:0.15 | 3.27 g | 16.4% | 0.5 g | 0 | 0 |
| 1 | | | | | | |
| Chassis | 0.7:0.2:0.1 | 4.56 g | 16.4% | 0.5 g | 0 | 0 |
| 2 | | | | | | |
| Chassis | 0.9:0.05:0.05 | 5.95 g | 16.4% | 0.5 g | 0 | 0 |
| 3 | | | | | | |

There are two parts of the formulations reported in Table 3B3: (1) three surfactant ratios (chassis) tested at different total active levels with varying chlorine scavenger inclusion levels; and (2) enhancement of their rinse scavenging ability with the addition of the carry over enhancer.

With regard to (1), all formulations were able to scavenge chlorine in the rinse (based on chlorine test strips) and the effect on color swatches could also be measured. These formulations were designed based on delivery of raw materials to the wash liquor so composition percentages will fluctuate depending on chassis type and dose size. Scavenging ability was not dependent on enzymes, dyes, or fragrances, these are all optional additions to the composition.

With regard to (2), beyond just inclusion of ingredients that can scavenge chlorine, there is a synergistic effect between ingredients that deposit onto the fabric and carry over of chlorine scavengers from the wash cycle to the rinse cycle.

The scope of color change of color swatches after 1 to 5 washes were captured and the data is provided in Table 4. “DE” means “Delta E”, a.k.a., ΔE. The method of testing and measuring ΔE has been described in Example 2 of the disclosure of Application No. 63/639,054. The multi-wash study was conducted with standard dyed woven cotton color swatches to view the color care impact of the inventive detergent compared to the control detergent and comparative commercial detergents. Dyed woven cotton swatches were subjected to standard top loader washing machine cycles as described above. Five cycles were conducted using three swatch replicates. A high heat tumble dry cycle was conducted after each wash cycle for 60 minutes before proceeding to the next wash cycle. The total color change (delta E) was measured using an XRite Ci7860 Spectrophotometer. The results are described in Table 4. The total color change observed using the inventive detergents is lower than compared to using the control detergents. A total color change of 1 unit or higher is the difference the naked eye can discern between samples.

TABLE 4
TOTAL DE VERSUS WASH

| | Total DE | | |
|---|---|---|---|
| Product | Wash 1 | Wash 3 | Wash 5 |
| Chassis 1 | 3.97 | 7.06 | 11.65 |
| Chassis 1 + Enhancer | 3.33 | 3.05 | 5.18 |
| Chassis 2 | 3.48 | 6.98 | 9.84 |
| Chassis 2 + Enhancer | 3.82 | 4.61 | 5.44 |
| Chassis 3 | 4.34 | 6.16 | 8.56 |
| Competitive Product 1 | 3.60 | 4.75 | 6.42 |
| Competitive Product 2 | 2.99 | 11.46 | 18.60 |
| Competitive Product 3 | 3.36 | 9.16 | 14.41 |
| Competitive Product 4 | 5.32 | 16.83 | 27.97 |

* “Enhancer” = carry-over enhancer agent

As can been seen from the results in Table 4, adding a carry-over enhancer in the formulas unexpectedly retain colors of color swatches, i.e., less fading, which suggests the synergistic effect of combining the carry-over enhancer and the chlorine scavenger in the compositions.

### Example 3

Test method 2 was used for verification that anti-redeposition polymers also serve as a carry-over enhancer agents for chlorine scavenging.

Test method 2: Small scale method in beakers mimicking wash (12 minutes) and rinse (4 minutes) cycles. The water started at 3 ppm chlorine and was measured at 1 minute intervals after each cycle stage started using chlorine indicator strips. If a sample read 0 ppm for 2 consecutive time points, no additional readings were taken for that cycle. Two anti-redeposition polymers were tested: anti-redep. polymer 1 is a polyacrylate and anti-redep. polymer 2 is a polyacrylate-polystyrene copolymer. The results are provided in Table 5.

TABLE 5

| | wash (min) | | | | rinse (min) | | | |
|---|---|---|---|---|---|---|---|---|
| Product | 0 | 1 | 2 | 3 | 0 | 1 | 2 | 3 |
| Chassis 1 + 0% anti-redep. | 0 | 0 | 0 | — | 3 | 3 | 3 | 2.5 |
| polymer 1 | ppm | ppm | ppm | | ppm | ppm | ppm | ppm |
| Chassis 1 + 0.185% active anti- | 0 | 0 | — | — | 3 | 3 | 3 | 2.5 |
| redep. polymer 1 | ppm | ppm | | | ppm | ppm | ppm | ppm |
| Chassis 1 + 0.555% active anti- | 0 | 0 | — | — | 3 | 2 | 2 | 1 |
| redep polymer 1 | ppm | ppm | | | ppm | ppm | ppm | ppm |
| Chassis 1 + 1.85% active anti- | 0 | 0 | — | — | 3 | 2 | 2 | 0.5 |
| redep. polymer 1 | ppm | ppm | | | ppm | ppm | ppm | ppm |
| Chassis 1 + 0% anti-redep. | 0 | 0 | 0 | — | 3 | 3 | 1.5 | 1 |
| polymer 2 | ppm | ppm | ppm | | ppm | ppm | ppm | ppm |
| Chassis 1 + 0.185% active anti- | 0 | 0 | — | — | 2 | 2 | 1 | 0.5 |
| redep. polymer 2 | ppm | ppm | | | ppm | ppm | ppm | ppm |
| Chassis 1 + 0.555% active anti- | 0 | 0 | — | — | 2 | 2 | 1 | 0.5 |
| redep. polymer 2 | ppm | ppm | | | ppm | ppm | ppm | ppm |
| Chassis 1 + 1.85% active anti- | 0 | 0 | — | — | 2 | 2 | 1 | 0.5 |
| redep. polymer 2 | ppm | ppm | | | ppm | ppm | ppm | ppm |

The compositions and methods disclosed herein include at least the following nonlimiting aspects:

Aspect 1: A detergent composition, comprising: 5.0 to about 30 wt % of an anionic surfactant; about 0.5% to about 10 wt % of a chlorine scavenger agent; about 0.1 to about 2 wt % of a carry-over enhancer agent, wherein the carry-over enhancer agent is a soil-release polymer, an anti-redeposition polymer, a cationic surfactant, a cationic polymer, a silicone-based polymer, or a combination thereof; and at least 30 wt % water; all weights are based on the total weight of the detergent composition; and wherein the detergent composition is free of a dye transfer inhibitor agent.

Aspect 2: The detergent composition of Aspect 1, wherein the chlorine scavenger agent is a lower alkyl amine, a hydroxyl-functional lower alkyl amine, an amino acid, or a combination thereof.

Aspect 3: The detergent composition of any one of Aspects 1-2, wherein the chlorine scavenger agent is monoethanolamine (MEA, also known as 2-aminoethan-1-ol), diethanolamine (DEA, also known as 2,2′-iminodiethan-1-ol), isopropanolamine, triethanolamine (TEA, also known as 2,2′,2″-nitrilotriethan-1-ol), lysine, or a combination thereof.

Aspect 4: The detergent composition of any one of Aspects 1-3, comprising about 1.0 to about 5 wt % of the chlorine scavenger agent.

Aspect 5: The detergent composition of any one of Aspects 1-3, comprising about 1.2 to about 2.5 wt % of the chlorine scavenger agent.

Aspect 6: The detergent composition of any one of Aspects 1-5, wherein the soil-release polymer is an acrylate copolymer, a comb or block copolymer, nonionic polypropylene terephthalate polyester, or a combination thereof.

Aspect 7: The detergent composition of any one of Aspects 1-5, wherein the soil-release polymer is a nonionic polypropylene terephthalate polyester.

Aspect 8: The detergent composition of any one of Aspects 1-7, wherein the anti-redeposition polymer is a polyacrylate, a polymethylacrylate, a methylacrylate, an acrylate copolymer, a styrene copolymer, a sodium methylacrylate styrene copolymer, a sulfonated condensate of phenol and formaldehyde, a comb or block copolymer, ethylene glycol polymer or copolymer, propylene glycol polymer or copolymer, or a combination thereof.

Aspect 9: The detergent composition of any one of Aspects 1-8, wherein the cationic surfactant is an alkylammonium, specifically a hydroxyalkyl-trialkyl-ammonium compound, and more specifically a C₁₂-lalkyl(hydroxy-ethyl)dimethylammonium compound, and the corresponding chloride salt thereof.

Aspect 10: The detergent composition of any one of Aspects 1-9, comprising about 0.5 to about 1.9 wt % of the carry-over enhancer agent.

Aspect 11: The detergent composition of any one of Aspects 1-9, comprising about 1.0 to about 1.8 wt % of the carry-over enhancer agent.

Aspect 12: The detergent composition of any one of Aspects 1-11, wherein the anionic surfactant is an alkylbenzene sulfonic acid, an alkyl ether sulfate, a polyethoxylated alcohol sulfate, a sodium lauryl ether sulfate, an alkali metal salt of a C₁₀-C₁₆ alkyl benzene sulfonic acid, a linear alkyl benzene sulfonate, a sodium or potassium straight chain alkylbenzene sulfonate, an α-sulfofatty acid ester, an ethoxysulfate, or a combination thereof.

Aspect 13: The detergent composition of any one of Aspects 1-11, wherein the anionic surfactant is a sodium laureth sulfate, a linear alkylbenzene sulfonic acid, or a combination thereof.

Aspect 14: The detergent composition of any one of Aspects 1-13, further comprising a builder, a nonionic surfactant, a chelant, a foam inhibitor, an optical brightener, an enzyme, a colorant, a fragrance, an organic solvent, a preservative, an antioxidant, or a combination thereof.

Aspect 15: The detergent composition of Aspect 14, wherein the nonionic surfactant is an alkoxylated fatty alcohol, an ethylene oxide (EO)-propylene oxide (PO) block polymer, an alcohol alkoxylate, a C₁₂-C₁₅ alcohol ethoxylate, an ethoxylated or ethoxylated and propoxylated fatty acid alkyl ester, a polyalkoxylated alkanolamide, a polyoxyalkylene alkyl ether, a polyoxyalkylene alkylphenyl ether, a polyoxyalkylene sorbitan fatty acid ester, a polyoxyalkylene sorbitol fatty acid ester, a polyalkylene glycol fatty acid ester, an alkyl polyalkylene glycol fatty acid ester, a polyoxyethylene polyoxypropylene alkyl ether, a polyoxyalkylene castor oil, a polyoxyalkylene alkylamine, a glycerol fatty acid ester, an alkylglucosamide, an alkylglucoside, an alkylamine oxide, or a combination thereof.

Aspect 16: A detergent composition, comprising: 5.0 to about 30 wt % of an anionic surfactant comprising a sodium laureth sulfate and a linear alkylbenzene sulfonic acid; about 0.5% to about 10 wt % of monoethanolamine; about 0.1 to about 2 wt % of a carry-over enhancer agent, wherein the carry-over enhancer agent is a soil-release polymer, an anti-redeposition polymer, a cationic surfactant, a cationic polymer, a silicone-based polymer, or a combination thereof; an alkoxylated fatty alcohol; and at least 30 wt % water; all weights are based on the total weight of the detergent composition; and wherein the detergent composition is free of a dye transfer inhibitor agent.

Aspect 17: The detergent composition of Aspect 16, comprising about 1.2 to about 2.5 wt % of monoethanolamine.

Aspect 18: The detergent composition of any one of Aspects 16-17, wherein the soil-release polymer is an acrylate copolymer, a comb or block copolymer, nonionic polypropylene terephthalate polyester, or a combination thereof; the anti-redeposition polymer is a polyacrylate, a polymethylacrylate, a methylacrylate, an acrylate copolymer, a styrene copolymer, a sodium methylacrylate styrene copolymer, a sulfonated condensate of phenol and formaldehyde, a comb or block copolymer, ethylene glycol polymer or copolymer, propylene glycol polymer or copolymer, or a combination thereof; and the cationic surfactant is an alkylammonium, specifically a hydroxyalkyl-trialkyl-ammonium compound, and more specifically a C₁₂₋₁₈alkyl(hydroxy-ethyl)dimethylammonium compound, and the corresponding chloride salt thereof.

Aspect 19: The detergent composition of any one of Aspects 16-18, comprising about 0.5 to about 1.9 wt % of the carry-over enhancer agent.

Aspect 20: A method of enhancing the chlorine scavenging ability of a detergent composition in a laundry rinse cycle, comprising: administering the detergent composition of any one of Aspects 1-19 and 21-24 in a wash cycle of a laundry washing process comprising a wash cycle followed by a rinse cycle.

Aspect 21: A detergent composition, consisting essentially of: 5.0 to about 30 wt % of an anionic surfactant; about 0.5% to about 10 wt % of a chlorine scavenger agent; about 0.1 to about 2 wt % of a carry-over enhancer agent, wherein the carry-over enhancer agent is a soil-release polymer, an anti-redeposition polymer, a cationic surfactant, a cationic polymer, a silicone-based polymer, or a combination thereof; at least 30 wt % water; and optionally one or more additional ingredient that is a builder, a nonionic surfactant, a chelant, a foam inhibitor, an optical brightener, an enzyme, a colorant, a fragrance, an organic solvent, a preservative, an antioxidant, or a combination thereof; all weights are based on the total weight of the detergent composition; and wherein the detergent composition is free of a dye transfer inhibitor agent.

Aspect 22: A detergent composition, consisting of: 5.0 to about 30 wt % of an anionic surfactant; about 0.5% to about 10 wt % of a chlorine scavenger agent; about 0.1 to about 2 wt % of a carry-over enhancer agent, wherein the carry-over enhancer agent is a soil-release polymer, an anti-redeposition polymer, a cationic surfactant, a cationic polymer, a silicone-based polymer, or a combination thereof; at least 30 wt % water; and optionally one or more additional ingredient that is a builder, a nonionic surfactant, a chelant, a foam inhibitor, an optical brightener, an enzyme, a colorant, a fragrance, an organic solvent, a preservative, an antioxidant, or a combination thereof; all weights are based on the total weight of the detergent composition; and wherein the detergent composition is free of a dye transfer inhibitor agent.

Aspect 23: A detergent composition, consisting essentially of: 5.0 to about 30 wt % of an anionic surfactant comprising a sodium laureth sulfate and a linear alkylbenzene sulfonic acid; about 0.5% to about 10 wt % of monoethanolamine; about 0.1 to about 2 wt % of a carry-over enhancer agent, wherein the carry-over enhancer agent is a soil-release polymer, an anti-redeposition polymer, a cationic surfactant, a cationic polymer, a silicone-based polymer, or a combination thereof; an alkoxylated fatty alcohol; at least 30 wt % water; and optionally one or more additional ingredient that is a builder, an additional nonionic surfactant, a chelant, a foam inhibitor, an optical brightener, an enzyme, a colorant, a fragrance, an organic solvent, a preservative, an antioxidant, or a combination thereof; all weights are based on the total weight of the detergent composition; and wherein the detergent composition is free of a dye transfer inhibitor agent.

Aspect 24: A detergent composition, consisting of: 5.0 to about 30 wt % of an anionic surfactant comprising a sodium laureth sulfate and a linear alkylbenzene sulfonic acid; about 0.5% to about 10 wt % of monoethanolamine; about 0.1 to about 2 wt % of a carry-over enhancer agent, wherein the carry-over enhancer agent is a soil-release polymer, an anti-redeposition polymer, a cationic surfactant, a cationic polymer, a silicone-based polymer, or a combination thereof; an alkoxylated fatty alcohol; at least 30 wt % water; and optionally one or more additional ingredient that is a builder, an additional nonionic surfactant, a chelant, a foam inhibitor, an optical brightener, an enzyme, a colorant, a fragrance, an organic solvent, a preservative, an antioxidant, or a combination thereof; all weights are based on the total weight of the detergent composition; and wherein the detergent composition is free of a dye transfer inhibitor agent.

Aspect 25: A method for cleaning or laundering an item comprising exposing an item or a wash liquor to a detergent composition of any one of Aspects 1-19 and 21-24; completing at least one wash cycle; and rinsing the item, wherein the item is a fabric

The breadth and scope of the present invention should not be limited by any of the above-described exemplary embodiments, but should be defined only in accordance with the following claims and their equivalents.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. “Combination” is inclusive of blends, mixtures, alloys, reaction products, and the like. The terms “a” and “an” and “the” herein do not denote a limitation of quantity, and are to be construed to cover both the singular and the plural, unless otherwise indicated herein or clearly contradicted by context. “Or” means “and/or.” The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The modifier “about” used in connection with a quantity is inclusive of the stated value and has the meaning dictated by the context (e.g., includes the degree of error associated with measurement of the particular quantity). The notation “+10%” means that the indicated measurement can be from an amount that is minus 10% to an amount that is plus 10% of the stated value. “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A detergent composition, comprising:
5.0 to about 30 wt % of an anionic surfactant;
about 0.5% to about 10 wt % of a chlorine scavenger agent;
about 0.1 to about 2 wt % of a carry-over enhancer agent, wherein the carry-over enhancer agent is a soil-release polymer, an anti-redeposition polymer, a cationic surfactant, a cationic polymer, a silicone-based polymer, or a combination thereof; and
at least 30 w t % water;
all weights are based on the total weight of the detergent composition; and
wherein the detergent composition is free of a dye transfer inhibitor agent.

2. The detergent composition of claim 1, wherein the chlorine scavenger agent is a lower alkyl amine, a hydroxyl-functional lower alkyl amine, an amino acid, or a combination thereof.

3. The detergent composition of claim 1, wherein the chlorine scavenger agent is monoethanolamine (MEA, also known as 2-aminoethan-1-ol), diethanolamine (DEA, also known as 2,2′-iminodiethan-1-ol), isopropanolamine, triethanolamine (TEA, also known as 2,2′,2″-nitrilotriethan-1-ol), lysine, or a combination thereof.

4. The detergent composition of claim 1, comprising about 1.0 to about 5 wt % of the chlorine scavenger agent.

5. The detergent composition of claim 1, comprising about 1.2 to about 2.5 wt % of the chlorine scavenger agent.

6. The detergent composition of claim 1, wherein the soil-release polymer is an acrylate copolymer, a comb or block copolymer, nonionic polypropylene terephthalate polyester, or a combination thereof.

7. The detergent composition of claim 1, wherein the soil-release polymer is a nonionic polypropylene terephthalate polyester.

8. The detergent composition of claim 1, wherein the anti-redeposition polymer is a polyacrylate, a polymethylacrylate, a methylacrylate, an acrylate copolymer, a styrene copolymer, a sodium methylacrylate styrene copolymer, a sulfonated condensate of phenol and formaldehyde, a comb or block copolymer, ethylene glycol polymer or copolymer, propylene glycol polymer or copolymer, or a combination thereof.

9. The detergent composition of claim 1, wherein the cationic surfactant is an alkylammonium, specifically a hydroxyalkyl-trialkyl-ammonium compound, and more specifically a C₁₂₋₁₈alkyl(hydroxy-ethyl)dimethylammonium compound, and the corresponding chloride salt thereof.

10. The detergent composition of claim 1, comprising about 0.5 to about 1.9 wt % of the carry-over enhancer agent.

11. The detergent composition of claim 1, comprising about 1.0 to about 1.8 wt % of the carry-over enhancer agent.

12. The detergent composition of claim 1, wherein the anionic surfactant is an alkylbenzene sulfonic acid, an alkyl ether sulfate, a polyethoxylated alcohol sulfate, a sodium lauryl ether sulfate, an alkali metal salt of a C₁₀-C₁₆alkyl benzene sulfonic acid, a linear alkyl benzene sulfonate, a sodium or potassium straight chain alkylbenzene sulfonate, an α-sulfofatty acid ester, an ethoxysulfate, or a combination thereof.

13. The detergent composition of claim 1, wherein the anionic surfactant is a sodium laureth sulfate, a linear alkylbenzene sulfonic acid, or a combination thereof.

14. The detergent composition of claim 1, further comprising a builder, a nonionic surfactant, a chelant, a foam inhibitor, an optical brightener, an enzyme, a colorant, a fragrance, an organic solvent, a preservative, an antioxidant, or a combination thereof.

15. The detergent composition of claim 1, wherein the nonionic surfactant is an alkoxylated fatty alcohol, an ethylene oxide (EO)-propylene oxide (PO) block polymer, an alcohol alkoxylate, a C₁₂-C₁₅ alcohol ethoxylate, an ethoxylated or ethoxylated and propoxylated fatty acid alkyl ester, a polyalkoxylated alkanolamide, a polyoxyalkylene alkyl ether, a polyoxyalkylene alkylphenyl ether, a polyoxyalkylene sorbitan fatty acid ester, a polyoxyalkylene sorbitol fatty acid ester, a polyalkylene glycol fatty acid ester, an alkyl polyalkylene glycol fatty acid ester, a polyoxyethylene polyoxypropylene alkyl ether, a polyoxyalkylene castor oil, a polyoxyalkylene alkylamine, a glycerol fatty acid ester, an alkylglucosamide, an alkylglucoside, an alkylamine oxide, or a combination thereof.

16. A detergent composition, comprising:
5.0 to about 30 wt % of an anionic surfactant comprising a sodium laureth sulfate and a linear alkylbenzene sulfonic acid;
about 0.5% to about 10 wt % of monoethanolamine;
about 0.1 to about 2 wt % of a carry-over enhancer agent, wherein the carry-over enhancer agent is a soil-release polymer, an anti-redeposition polymer, a cationic surfactant, a cationic polymer, a silicone-based polymer, or a combination thereof;
an alkoxylated fatty alcohol; and
at least 30 w t % water;
all weights are based on the total weight of the detergent composition; and
wherein the detergent composition is free of a dye transfer inhibitor agent.

17. The detergent composition of claim 16, comprising about 1.2 to about 2.5 wt % of monoethanolamine.

18. The detergent composition of claim 16, wherein
the soil-release polymer is an acrylate copolymer, a comb or block copolymer, nonionic polypropylene terephthalate polyester, or a combination thereof;
the anti-redeposition polymer is a polyacrylate, a polymethylacrylate, a methylacrylate, an acrylate copolymer, a styrene copolymer, a sodium methylacrylate styrene copolymer, a sulfonated condensate of phenol and formaldehyde, a comb or block copolymer, ethylene glycol polymer or copolymer, propylene glycol polymer or copolymer, or a combination thereof; and
the cationic surfactant is an alkylammonium, specifically a hydroxyalkyl-trialkyl-ammonium compound, and more specifically a C₁₂₋₁₈alkyl(hydroxy-ethyl)dimethylammonium compound, and the corresponding chloride salt thereof.

19. The detergent composition of claim 16, comprising about 0.5 to about 1.9 wt % of the carry-over enhancer agent.

20. A method of enhancing the chlorine scavenging ability of a detergent composition in a laundry rinse cycle, comprising: administering the detergent composition of claim 1 in a wash cycle of a laundry washing process comprising a wash cycle followed by a rinse cycle.
